(19) United States
(12) Patent Application Publication
(10) Pub. No.: US 2010/0025989 A1
(43) Pub. Date: Feb. 4, 2010

(54) CHEMICAL AND BIOLOGICAL CLEAN AIR CONNECTOR

(75) Inventor: John J. McKeon, III, Hamden, CT (US)

Correspondence Address: MILLS & ONELLO LLP, ELEVEN BEACON STREET, SUITE 605, BOSTON, MA, 02108, US

(73) Assignee: AIR-LOCK, INC., Milford, CT (US)

(21) Appl. No.: 12/575,622

(22) Filed: Oct. 8, 2009

Related U.S. Application Data
(62) Division of application No. 11/805,811, filed on May 24, 2007.

(51) Int. Cl. F16L 35/00

(52) U.S. Cl. 285/328

(57) ABSTRACT

A connector for use in a contaminated environment is provided. The connector includes first and second couplers which are coupled together to produce a fluid path through the connector. Prior to coupling of the first and second couplers, the first and second couplers include plastic caps for minimizing the contaminants on the couplers. Elastomer face seals which can be contaminated are mated against one another compressing to expel contaminants and trapping contaminants between the elastomer face seals. The elastomer face seals are captured between a pair of O-rings. Parts of the elastomer face seals are flushed with fluid as the connector is coupled to further reduce contamination. All internal passages and the elastomer face seals are treated with an antimicrobial compound. The connector vents to the atmosphere during engagement of the first and second couplers such that the connector can operate at a higher pressure with reduced engagement force.

This application is a divisional application of U.S. patent application Ser. No. 11/805,811, filed on May 24, 2007, the contents of which application are incorporated herein in their entirety by reference.

### BACKGROUND OF THE INVENTION

1. Field of the Invention

This invention relates generally to connectors or couplings for joining together the ends of two hoses, tubes or the like. This invention relates in particular to a connector which is of the quick connect/disconnect type, is used as part of a system for supplying air to a person in a contaminated environment, and prevents chemical and biological contaminants in the environment from entering into the air supply as the coupling between hoses is formed.

2. Description of the Related Art

Clean air supplies are needed by persons working in contaminated environments as well as by military personnel in situations where biological or chemical weapons are employed. Some contaminants are so toxic that even introduction of minute amounts of the contaminant into a person's air supply can be debilitating or lethal.

Couplings between air supply hoses often need to be made within a contaminated environment. Under these conditions, contaminants on the surfaces of the connector can be introduced into the air stream as the coupling is formed. Preventing such introduction is a difficult problem.

U.S. Pat. No. 4,949,745 (hereinafter “the '745 patent”), incorporated herein by reference, describes a clean air connector. The clean air connector of the '745 patent includes hard surfaces 126, 128, 130 and 132 (see FIG. 4 of the '745 patent) that are exposed to contaminants when the supply end of the connector and the receiver end of the connector are in an uncoupled position. In the '745 patent hard surfaces 126, 128, 130 and 132 come into contact to physically capture the contaminants present on the mating portions of the these surfaces. Although the surfaces are in contact, motion between the surfaces which can release contamination, e.g., rocking of the surfaces against one another, can still take place. The surfaces coming together are two hard surfaces such that a proper seal is not created and contaminants can still escape into the air supply. In addition, the clean air connector of the '745 patent is designed to operate at low pressure (approximately 2-4 PSI). When the clean air connector of the '745 patent is used with higher pressure, the clean air connector has a relatively high engagement force.

### SUMMARY OF THE INVENTION

The present invention is directed to a connector for carrying a fluid having a coupled state and an uncoupled state. The connector includes first and second subassemblies. The first and second subassemblies are engaged in the coupled state and disconnected in the uncoupled state. The connector further includes first and second removable caps that cover contaminable surfaces exposed to the surroundings in the uncoupled state. The first and second caps are removed in the coupled state. The connector further includes a fluid path through the first and second subassemblies that is sealed from the surroundings in the coupled state. The connector also includes an isolating structure that isolates the contaminable surfaces from the fluid path in the coupled state.

In one embodiment, the connector includes first and second elastomer face seals formed on the first and second subassemblies, respectively. In another embodiment, the first and second elastomer face seals are exposed to the surrounding environment when the connector is in the uncoupled state. In another embodiment, the first and second elastomer face seals are compressible. In another embodiment, the first elastomer face seal is in contact with the second elastomer face seal when the connector is in its coupled state. In another embodiment, the connector further includes means for passing fluid over a portion of the first and second elastomer face seals and out of the connector during engagement of the first and second subassemblies.

In one embodiment, the connector further includes an antimicrobial compound formed on internal passages of the connector.

In one embodiment, the connector further includes an aperture to vent to the atmosphere during engagement of the first and second subassemblies.

In one embodiment, the contaminable surfaces are isolated between a pair of O-rings when the connector is in its coupled state.

In one embodiment, the first subassembly has a sealed state in which fluid cannot pass through the subassembly and an unsealed state in which fluid can pass through the subassembly. The first subassembly is in its sealed state when the connector is in its uncoupled state and is in its unsealed state when the connector is in its coupled state. The connector includes means for transferring the first subassembly from its sealed to its unsealed state as the first and second subassemblies are coupled together.

In one embodiment, the second subassembly has a sealed state in which fluid cannot pass through the subassembly and an unsealed state in which fluid can pass through the subassembly. The second subassembly is in its sealed state when the connector is in its uncoupled state and is in its unsealed state when the connector is in its coupled state. The connector includes means for transferring the second subassembly from its sealed to its unsealed state as the first and second subassemblies are coupled together, said transferring to the unsealed state occurring after the means for isolating has isolated the contaminable surfaces from the fluid path.

In accordance with another aspect of the invention, the invention is directed to a connector for carrying a fluid having a coupled state and an uncoupled state. The connector includes first and second subassemblies. The first and second subassemblies are engaged in the coupled state and disconnected in the uncoupled state. First and second elastomer face seals are formed on the first and second subassemblies, respectively. The first and second elastomer face seals are exposed to the surrounding environment when the connector is in the uncoupled state. The first and second elastomer face seals are compressible. The connector further includes a fluid path through the first and second subassemblies that is sealed from the surroundings in the coupled state. The connector further includes an isolating structure that isolates the elastomer face seals from the fluid path in the coupled state.

In one embodiment, the first elastomer face seal is in contact with the second elastomer face seal when the connector is in its coupled state.

In one embodiment, the connector further includes means for passing fluid over a portion of the first and second elastomer face seals and out of the connector during engagement of the first and second subassemblies.

In one embodiment, the connector further includes an antimicrobial compound formed on internal passages of the connector.

In one embodiment, the connector further includes an aperture to vent to the atmosphere during engagement of the first and second subassemblies.

In one embodiment, the contaminable surfaces are isolated between a pair of O-rings when the connector is in its coupled state.

In one embodiment, the first subassembly has a sealed state in which fluid cannot pass through the subassembly and an unsealed state in which fluid can pass through the subassembly. The first subassembly is in its sealed state when the connector is in its uncoupled state and is in its unsealed state when the connector is in its coupled state. The connector includes means for transferring the first subassembly from its sealed to its unsealed state as the first and second subassemblies are coupled together.

In one embodiment, the second subassembly has a sealed state in which fluid cannot pass through the subassembly and an unsealed state in which fluid can pass through the subassembly. The second subassembly is in its sealed state when the connector is in its uncoupled state and is in its unsealed state when the connector is in its coupled state. The connector includes means for transferring the second subassembly from its sealed to its unsealed state as the first and second subassemblies are coupled together, said transferring to the unsealed state occurring after the means for isolating has isolated the contaminable surfaces from the fluid path.

In accordance with another aspect of the invention, the invention is directed to a connector for carrying a fluid having a coupled state and an uncoupled state. The connector includes first and second subassemblies. The first and second subassemblies are engaged in the coupled state and disconnected in the uncoupled state and the first and second subassemblies have contaminable surfaces in the uncoupled state. The connector further includes a fluid path through the first and second subassemblies that is sealed from the surroundings in the coupled state. The connector further includes an isolating structure that isolates the contaminable surfaces from the fluid path in the coupled state. The connector further includes an antimicrobial compound formed on internal passages of the connector.

In one embodiment, the connector further includes an aperture to vent to the atmosphere during engagement of the first and second subassemblies.

In one embodiment, the contaminable surfaces are isolated between a pair of O-rings when the connector is in its coupled state.

In one embodiment, the first subassembly has a sealed state in which fluid cannot pass through the subassembly and an unsealed state in which fluid can pass through the subassembly. The first subassembly is in its sealed state when the connector is in its uncoupled state and is in its unsealed state when the connector is in its coupled state. The connector includes means for transferring the first subassembly from its sealed to its unsealed state as the first and second subassemblies are coupled together.

In one embodiment, the second subassembly has a sealed state in which fluid cannot pass through the subassembly and an unsealed state in which fluid can pass through the subassembly. The second subassembly is in its sealed state when the connector is in its uncoupled state and is in its unsealed state when the connector is in its coupled state. The connector includes means for transferring the second subassembly from its sealed to its unsealed state as the first and second subassemblies are coupled together, said transferring to the unsealed state occurring after the means for isolating has isolated the contaminable surfaces from the fluid path.

In accordance with another aspect of the invention, the invention is directed to a connector for carrying a fluid having a coupled state and an uncoupled state that includes first and second subassemblies. The first and second subassemblies are engaged in the coupled state and disconnected in the uncoupled state. The first and second subassemblies have contaminable surfaces in the uncoupled state. The connector further includes an aperture to vent to the atmosphere during engagement of the first and second subassemblies. The connector further includes a fluid path through the first and second subassemblies that is sealed from the surroundings in the coupled state. The connector further includes an isolating structure that isolates the contaminated surfaces from the fluid path in the coupled state.

In one embodiment, the contaminable surfaces are isolated between a pair of O-rings when the connector is in its coupled state.

In one embodiment, the first subassembly has a sealed state in which fluid cannot pass through the subassembly and an unsealed state in which fluid can pass through the subassembly. The first subassembly is in its sealed state when the connector is in its uncoupled state and is in its unsealed state when the connector is in its coupled state. The connector includes means for transferring the first subassembly from its sealed to its unsealed state as the first and second subassemblies are coupled together.

In one embodiment, the second subassembly has a sealed state in which fluid cannot pass through the subassembly and an unsealed state in which fluid can pass through the subassembly. The second subassembly is in its sealed state when the connector is in its uncoupled state and is in its unsealed state when the connector is in its coupled state. The connector includes means for transferring the second subassembly from its sealed to its unsealed state as the first and second subassemblies are coupled together, said transferring to the unsealed state occurring after the means for isolating has isolated the contaminable surfaces from the fluid path.

In accordance with another aspect of the invention, the invention is directed to a method for coupling a first subassembly and a second subassembly of a connector. The method includes removing first and second removable caps from the first and second subassemblies. The first and second removable caps cover contaminable surfaces of the first and second subassemblies, respectively. The method further includes engaging the first and second subassemblies. The method further includes forming a fluid path through the first and second subassemblies and isolating the contaminable surfaces from the fluid path.

In one embodiment, the method further includes treating internal passages of the first and second subassemblies with an antimicrobial compound.

In one embodiment, the first and second subassemblies include first and second elastomer face seals. In another embodiment, the method further includes compressing the first and second elastomer face seals during engagement of the first and second subassemblies.

In one embodiment, the method further includes passing a fluid over a portion of the contaminated surfaces as the couplers are engaged.

In one embodiment, the method further includes venting to the atmosphere during the engagement of the first and second subassemblies.

In one embodiment, the method further includes sealing the second subassembly during engagement and opening the second subassembly only after the contaminated surfaces have been isolated.

In accordance with another aspect of the invention, the invention is directed to a method for coupling a first subassembly and a second subassembly of a connector. The method includes engaging the first and second subassemblies having first and second elastomer face seals, respectively. The elastomer face seals are contaminable surfaces. The method further includes forming a fluid path through the first and second subassemblies and isolating the contaminable surfaces from the fluid path.

In one embodiment, the method further includes compressing the first and second elastomer face seals during engagement of the first and second subassemblies.

In one embodiment, the method further includes treating internal passages of the first and second subassemblies with an antimicrobial compound.

In one embodiment, the method further includes passing a fluid over a portion of the contaminated surfaces as the couplers are engaged.

In one embodiment, the method further includes venting to the atmosphere during the engagement of the first and second subassemblies.

In one embodiment, the method further includes sealing the second subassembly during engagement and opening the second subassembly only after the elastomer face seals and contaminated surfaces have been isolated.

In accordance with another aspect of the invention, the invention is directed to a method for coupling a first subassembly and a second subassembly of a connector. The method includes treating internal passages of the first and second subassemblies with an antimicrobial compound, engaging the first and second subassemblies, forming a fluid path through the first and second subassemblies, and isolating the contaminable surfaces from the fluid path.

In one embodiment, the method further includes passing a fluid over a portion of the contaminated surfaces as the couplers are engaged.

In one embodiment, the method further includes venting to the atmosphere during the engagement of the first and second subassemblies.

In one embodiment, the method further includes sealing the second subassembly during engagement and opening the second subassembly only after the elastomer face seals and contaminated surfaces have been isolated

In accordance with another aspect of the invention, the invention is directed to a method for coupling a first subassembly and a second subassembly of a connector. The method includes engaging the first and second subassemblies, venting to the atmosphere during the engagement of the first and second subassemblies, forming a fluid path through the first and second subassemblies, and isolating the contaminable surfaces from the fluid path.

In one embodiment, the method further includes passing a fluid over a portion of the contaminated surfaces as the couplers are engaged.

In one embodiment, the method further includes sealing the second subassembly during engagement and opening the second subassembly only after the elastomer face seals and contaminated surfaces have been isolated.

### BRIEF DESCRIPTION OF THE DRAWINGS

The foregoing and other objects, features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic partially cut-away cross-sectional and perspective view of a connector in accordance with an embodiment of the invention.

FIG. 2A is a schematic partially cut-away cross-sectional and perspective view of the connector in accordance with an embodiment of the invention. FIG. 2B is a detailed view of a section of FIG. 2A in accordance with an embodiment of the invention.

FIG. 3A is a schematic partially cut-away cross-sectional and perspective view of the connector in accordance with an embodiment of the invention. FIG. 3B is a detailed view of a section of FIG. 3A in accordance with an embodiment of the invention.

FIG. 4A is a schematic partially cut-away cross-sectional and perspective view of the connector in accordance with an embodiment of the invention. FIG. 4B is a detailed view of a section of FIG. 4A in accordance with an embodiment of the invention.

FIG. 5A is a schematic partially cut-away cross-sectional and perspective view of the connector in accordance with an embodiment of the invention. FIG. 5B is a detailed view of a section of FIG. 5A in accordance with an embodiment of the invention.

FIG. 6A is a schematic partially cut-away cross-sectional and perspective view of the connector in accordance with an embodiment of the invention. FIG. 6B is a detailed view of a section of FIG. 6A in accordance with an embodiment of the invention.

FIG. 7A is a schematic partially cut-away cross-sectional and perspective view of the connector in accordance with an embodiment of the invention. FIG. 7B is a detailed view of a section of FIG. 7A in accordance with an embodiment of the invention.

FIG. 8A is a schematic partially cut-away cross-sectional and perspective view of the connector 10 in accordance with an embodiment of the invention. FIG. 8B is a detailed view of a section of FIG. 8A in accordance with an embodiment of the invention.

### DETAILED DESCRIPTION OF PREFERRED EMBODIMENTS OF THE INVENTION

The present invention as described below is applicable to the clean air connector of U.S. Pat. No. 4,949,745 (the '745 patent), incorporated herein by reference. The details of the connection of the clean air connector of the '745 patent are therefore not repeated below. The clean air connector of the present invention provides certain improvements over the clean air connector of the '745 patent.

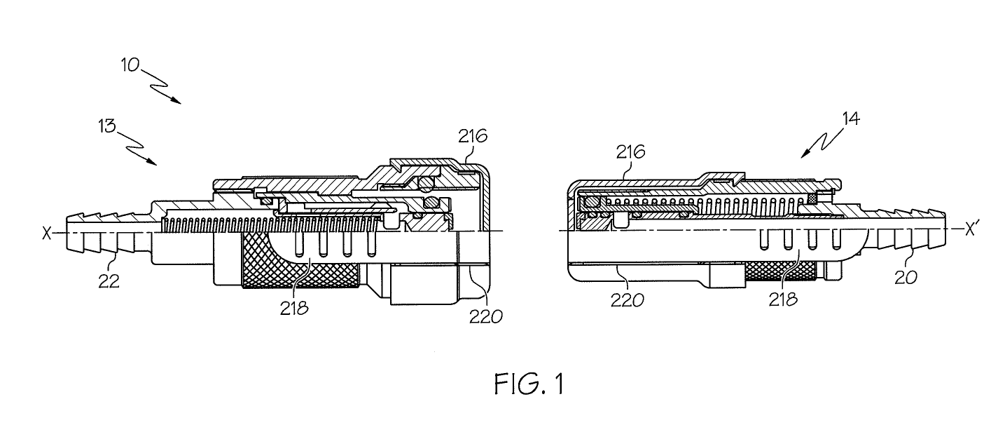

FIG. 1 is a schematic partially cut-away cross-sectional and perspective view of a connector 10 in accordance with an embodiment of the invention. The cut-away cross-sectional view is shown above line X-X′, and the perspective view is shown below line X-X′. The connector includes two subassemblies 13 and 14, with the direction of fluid flow in the assembled connector being from subassembly 13 to subassembly 14. Subassembly 13 is the supply end of the connector 10 and subassembly 14 is the receiver end of the connector 10. Subassembly 13 includes a barbed hose end 22 which is designed for connection to a hose, tube or other fluid-carrying conduit. Subassembly 14 includes a barbed hose end 20 which is designed for connection to a hose, tube or other fluid-carrying conduit. For example, the hose end 22 can be coupled to a pressurized source of air or other breathable mixture of gases and the hose end 20 can be coupled to a person's mask, helmet or sealed suit. The connector 10 can be used for the transport of gas or liquid.

When the connector 10 is in the uncoupled position as shown in FIG. 1, the mating ends of the subassemblies 13 and 14 are closed and are further protected by removable plastic caps 216. The plastic caps 216 minimize the amount of contamination buildup on the surface of the connectors prior to use. The plastic caps 216 are pressed onto the mating ends of the subassemblies 13 and 14 and are preferably composed of polyethylene or vinyl. The removable plastic caps 216 have tear-off tabs 218. Prior to coupling the subassemblies 13, 14, the plastic caps are removed by pulling the tear-off tabs 218 along seams 220. The tear-off tabs 218 are not reusable. Once the plastic caps 216 are removed, the connector subassemblies 13, 14 are exposed to whatever contaminants are present in the immediate atmosphere. The plastic caps 216 reduce the amount of time the subassemblies 13, 14 are exposed thereby minimizing the amount of contamination buildup.

The remaining figures illustrate in detail the connection sequence for connecting the connector subassemblies 13, 14.

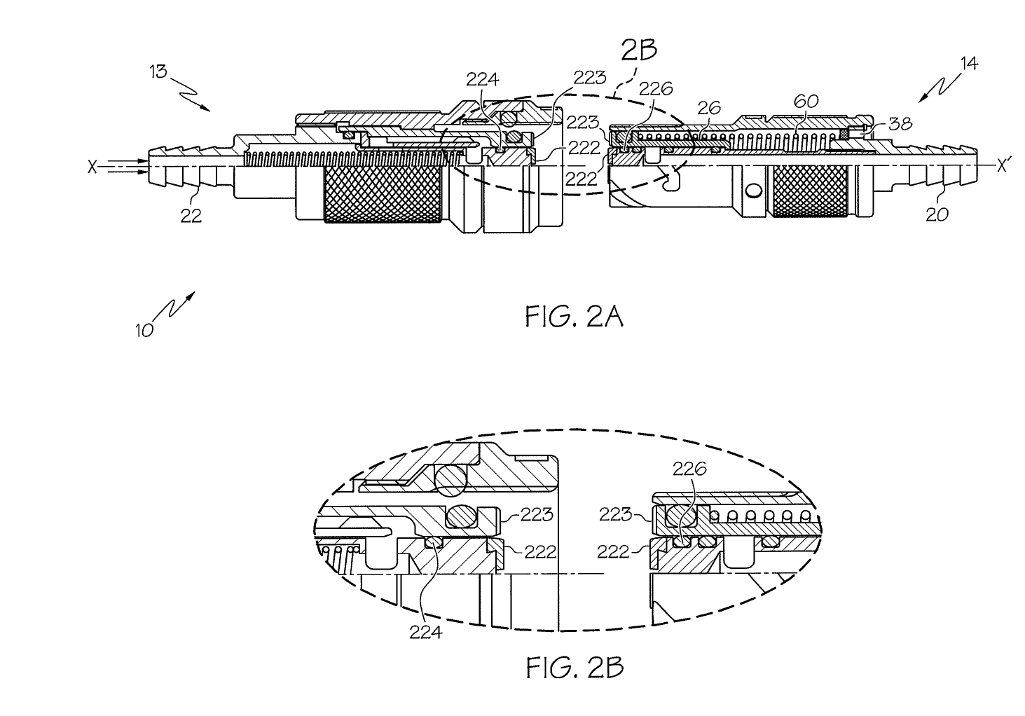

FIG. 2A is a schematic partially cut-away cross-sectional and perspective view of the connector 10 in accordance with an embodiment of the invention. FIG. 2B is a detailed view of a section of FIG. 2A shown in dashed lines in accordance with an embodiment of the invention. In FIGS. 2A and 2B the plastic caps 216 have been removed. Elastomer face seals 222 and vent channels 223 on the subassemblies 13, 14 are exposed to contaminants. Each subassembly 13, 14 is sealed against any intrusion of contaminants from the environment into the internal passages by O-ring 224 of subassembly 13 and O-ring 226 of subassembly 14. Subassembly 14 includes shuttle valve 26. Aperture 38 vents chamber 60 to the atmosphere as the shuttle valve moves relative to the inner and outing housings. Aperture 38 venting to the atmosphere permits the shuttle valve 26 to move without compressing air such that the connector can operate at a higher pressure with reduced engagement force.

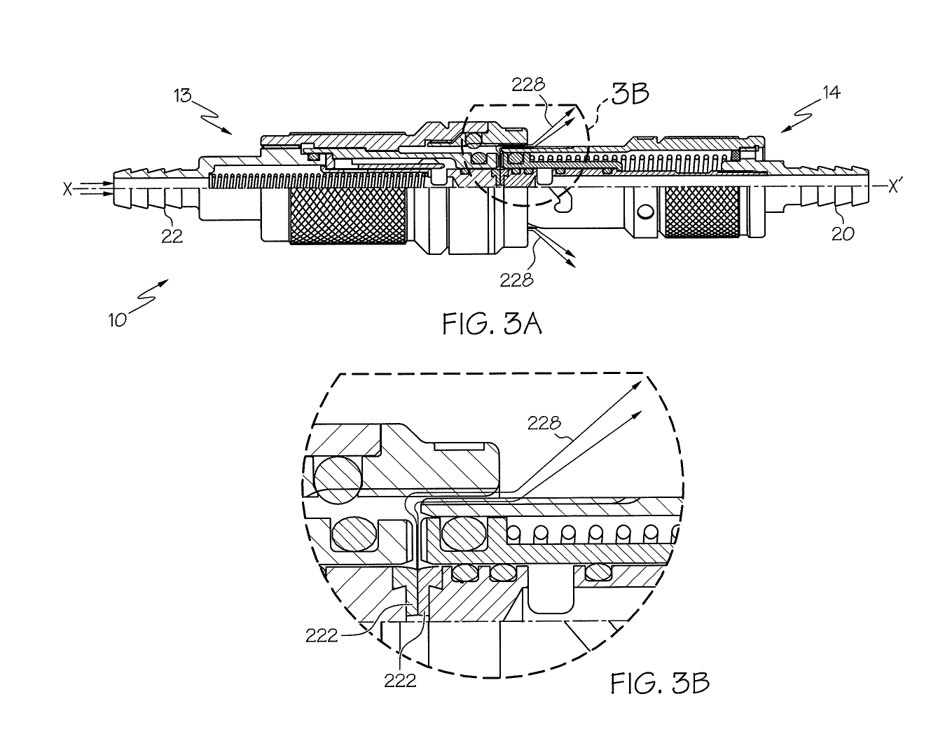

FIG. 3A is a schematic partially cut-away cross-sectional and perspective view of the connector 10 in accordance with an embodiment of the invention. FIG. 3B is a detailed view of a section of FIG. 3A shown in dashed lines in accordance with an embodiment of the invention. In FIGS. 3A and 3B, the elastomer face seals 222 have made initial contact with one another during the engagement process. The elastomer face seals 222 may have become contaminated between the time that the plastic caps were removed and the start of the engagement. As the elastomer face seals 222 contact each other some of the contaminants are forced away from the elastomer face seals 222 along path 228 and are expelled from the connector.

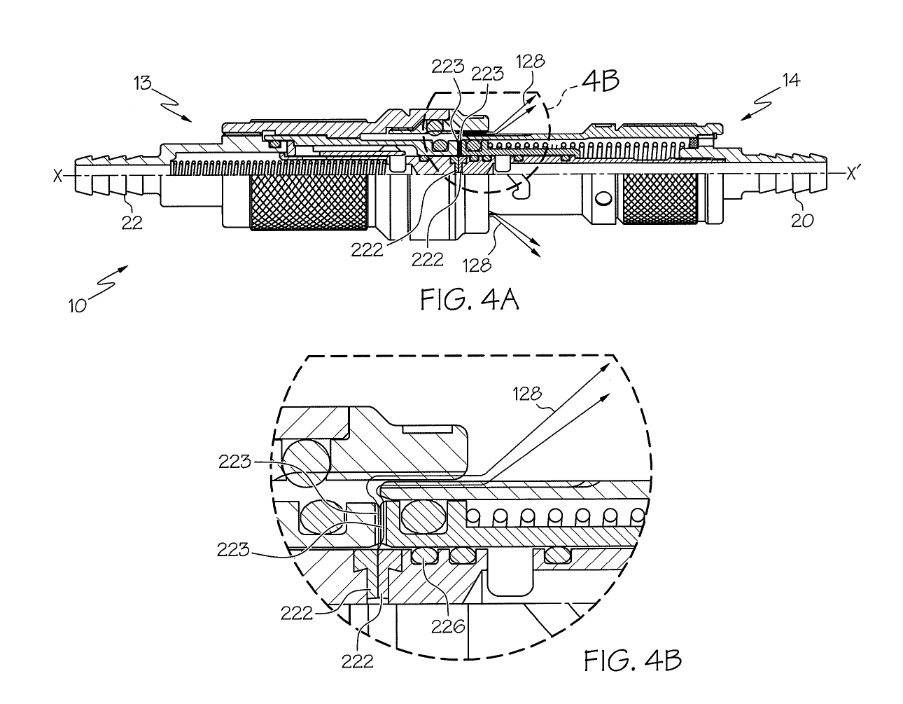

FIG. 4A is a schematic partially cut-away cross-sectional and perspective view of the connector 10 in accordance with an embodiment of the invention. FIG. 4B is a detailed view of a section of FIG. 4A shown in dashed lines in accordance with an embodiment of the invention. In FIGS. 4A and 4B, the elastomer face seals 222 are under compression. As the elastomer face seals 222 compress, the contaminants between the elastomer face seals 222 are expelled through the vent channels 223. The remaining contaminants are captured between the elastomer face seals 222. As the elastomer face seals 222 are not hard surfaces, they create a better seal than the surfaces in the '745 patent.

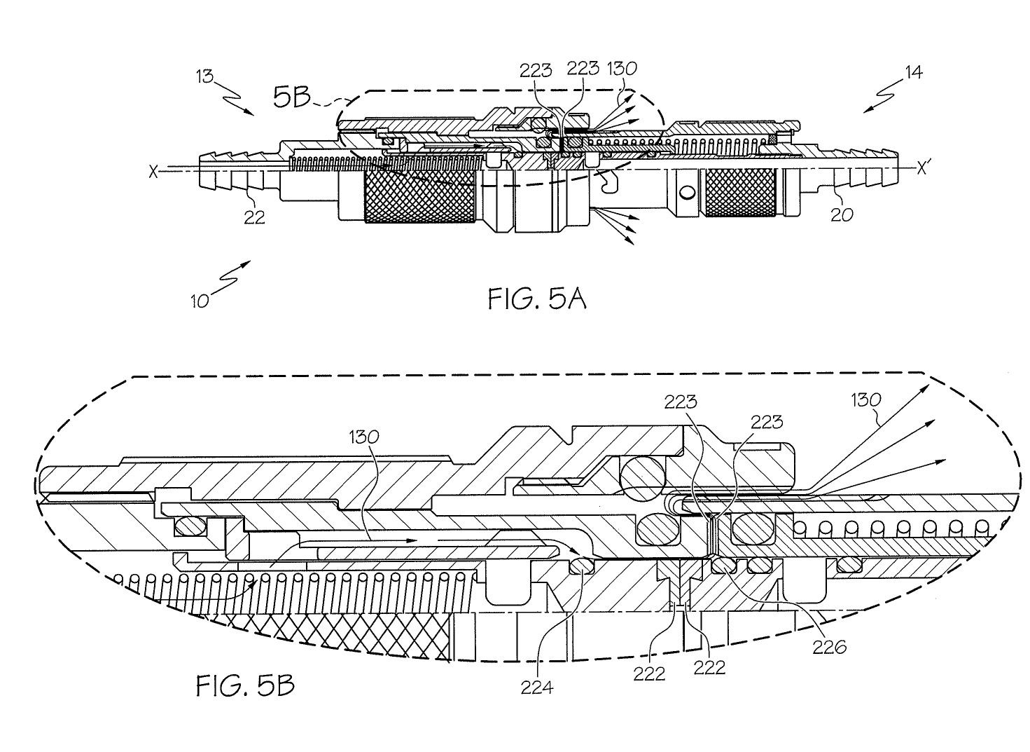

FIG. 5A is a schematic partially cut-away cross-sectional and perspective view of the connector 10 in accordance with an embodiment of the invention. FIG. 5B is a detailed view of a section of FIG. 5A shown in dashed lines in accordance with an embodiment of the invention. As the engagement of the subassemblies 13, 14 continues, the poppet O-ring 224 moves beyond its sealed position permitting gas to flow through path 130. The path 130 is flushed with fluid to further reduce contamination. The gas flow purges contaminants from the previously exposed diameter of the poppet O-ring 224, the outer edges of the elastomer face seals 222 and outer faces of both of the subassemblies 13 and 14 through vent channels 223. The internal passages of subassembly 14 are sealed off by O-ring 226 such that no gas flow enters subassembly 14.

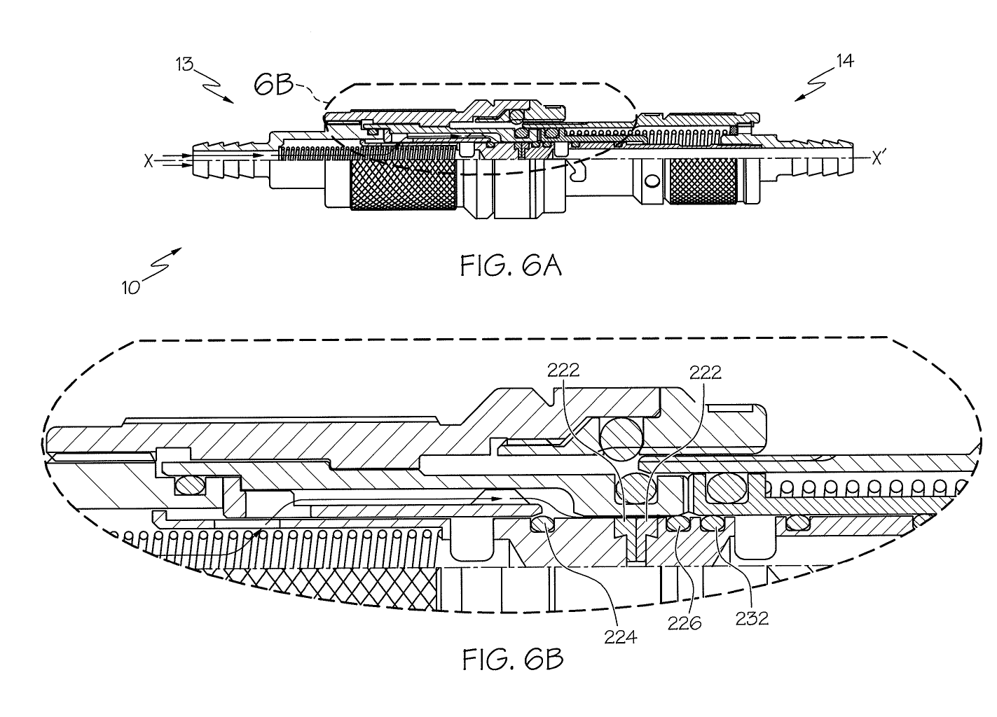

FIG. 6A is a schematic partially cut-away cross-sectional and perspective view of the connector 10 in accordance with an embodiment of the invention. FIG. 6B is a detailed view of a section of FIG. 6A shown in dashed lines in accordance with an embodiment of the invention. In FIGS. 6A and 6B, the flow of gas from subassembly 13 is blocked by O-ring 226 of subassembly 14. O-ring 232 remains in a sealing position. O-rings 226 and 232 seal off the internal gas flow passages from any external contamination.

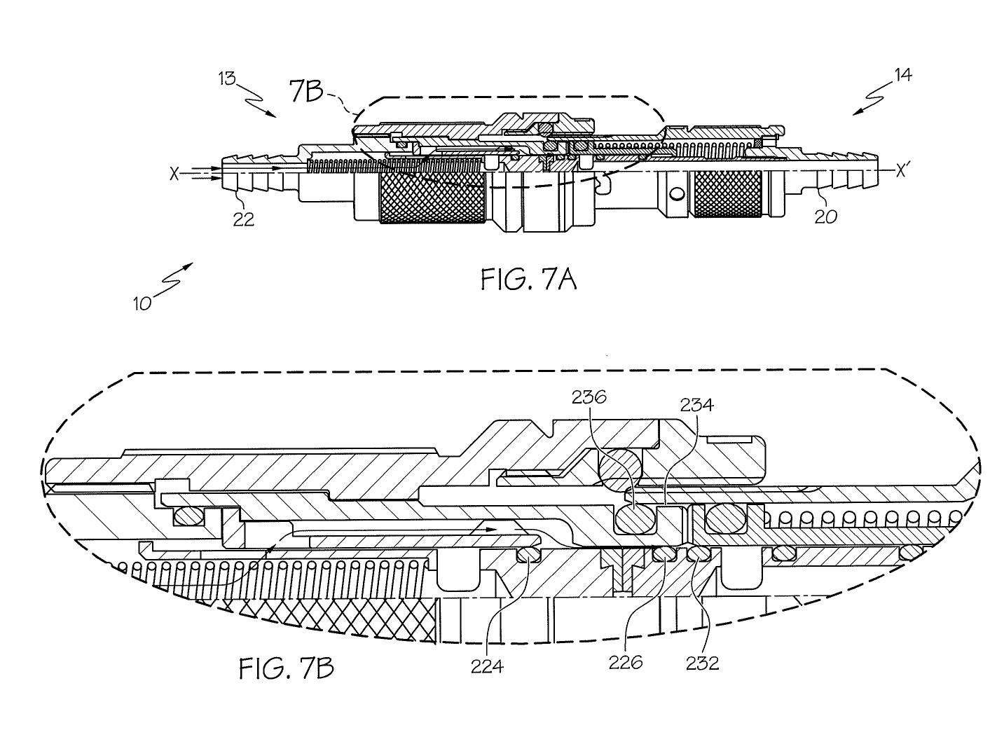

FIG. 7A is a schematic partially cut-away cross-sectional and perspective view of the connector 10 in accordance with an embodiment of the invention. FIG. 7B is a detailed view of a section of FIG. 7A shown in dashed lines in accordance with an embodiment of the invention. In FIGS. 7A and 7B, before the O-ring 232 of subassembly 14 is disengaged from a sealed position, outer shell 234 of subassembly 14 engages outer O-ring 236 of subassembly 13 such that a continued isolation of internal gas passages from external contamination is provided.

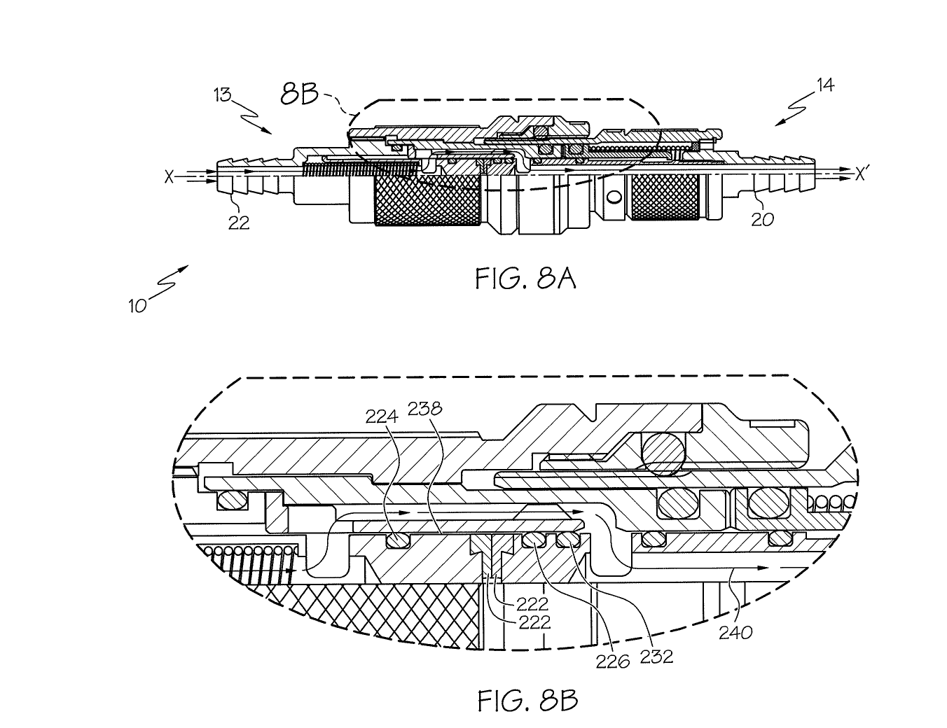

FIG. 8A is a schematic partially cut-away cross-sectional and perspective view of the connector 10 in accordance with an embodiment of the invention. FIG. 8B is a detailed view of a section of FIG. 8A shown in dashed lines in accordance with an embodiment of the invention. FIGS. 8A and 8B illustrate the fully engaged position. In FIGS. 8A and 8B, the internal surfaces of the fluid path are sealed off from the surrounding environment and external contamination. The surfaces which had been exposed to the surrounding environment are trapped within an internal sleeve 238 by poppet O-ring 224 and O-ring 226 and are sealed off from the breathable gas flow. The subassemblies are coupled together to produce a fluid path 240 through the connector. The outer boundaries of the fluid path define a fluid path envelope. The elastomer face seals 222 are mated and lie within the fluid path envelope.

All surfaces that come in contact with the gas, or liquid are coated or impregnated with an antimicrobial compound. The antimicrobial compound kills any microorganisms that may be on the surfaces of the connector 10. Hard surfaces such as aluminum are coated with the antimicrobial compound, while the elastomer face seals are impregnated with the antimicrobial compound.

In accordance with the invention, prior to use of the connector, each subassembly of the connector is protected by a plastic cap to minimize exposure of the connector to contamination in the surrounding environment. Each subassembly utilizes an elastomer face seal. The elastomer face seals expel some of the contaminants that are on the elastomer face seal as the elastomer compresses during engagement, and the remaining contaminants are trapped between the two elastomer face seals. The internal passages and the elastomer seals of the connector are treated with an antimicrobial compound. As a result of these contamination control procedures, the connector can be assembled in a contaminated environment without introducing contamination into the fluid stream passing through the connector. The connector can operate at a high pressure by venting to the atmosphere.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method for coupling a first subassembly and a second subassembly of a connector, comprising:
removing first and second removable caps from the first and second subassemblies, the first and second removable caps covering contaminable surfaces of the first and second subassemblies, respectively;
engaging the first and second subassemblies;
forming a fluid path through the first and second subassemblies; and
isolating the contaminable surfaces from the fluid path.

2. The method of claim 1, further comprising treating internal passages of the first and second subassemblies with an antimicrobial compound.

3. The method of claim 1, wherein the first and second subassemblies include first and second elastomer face seals.

4. The method of claim 3, further comprising compressing the first and second elastomer face seals during engagement of the first and second subassemblies.

5. The method of claim 1, further comprising passing a fluid over a portion of the contaminated surfaces as the couplers are engaged.

6. The method of claim 1, further comprising venting to the atmosphere during the engagement of the first and second subassemblies.

7. The method of claim 1, further comprising sealing the second subassembly during engagement and opening the second subassembly only after the contaminated surfaces have been isolated.

8. A method for coupling a first subassembly and a second subassembly of a connector, comprising:
engaging the first and second subassemblies having first and second elastomer face seals, respectively, wherein the elastomer face seals are contaminable surfaces;
forming a fluid path through the first and second subassemblies; and
isolating the contaminable surfaces from the fluid path.

9. The method of claim 8, further comprising compressing the first and second elastomer face seals during engagement of the first and second subassemblies.

10. The method of claim 8, further comprising treating internal passages of the first and second subassemblies with an antimicrobial compound.

11. The method of claim 8, further comprising passing a fluid over a portion of the contaminated surfaces as the couplers are engaged.

12. The method of claim 8, further comprising venting to the atmosphere during the engagement of the first and second subassemblies.

13. The method of claim 8, further comprising sealing the second subassembly during engagement and opening the second subassembly only after the elastomer face seals and contaminated surfaces have been isolated.

14. A method for coupling a first subassembly and a second subassembly of a connector, comprising:
treating internal passages of the first and second subassemblies with an antimicrobial compound;
engaging the first and second subassemblies;
forming a fluid path through the first and second subassemblies; and
isolating the contaminable surfaces from the fluid path.

15. The method of claim 14, further comprising passing a fluid over a portion of the contaminated surfaces as the couplers are engaged.

16. The method of claim 14, further comprising venting to the atmosphere during the engagement of the first and second subassemblies.

17. The method of claim 14, further comprising sealing the second subassembly during engagement and opening the second subassembly only after the elastomer face seals and contaminated surfaces have been isolated

18. A method for coupling a first subassembly and a second subassembly of a connector, comprising:
engaging the first and second subassemblies;
venting to the atmosphere during the engagement of the first and second subassemblies;
forming a fluid path through the first and second subassemblies; and
isolating the contaminable surfaces from the fluid path.

19. The method of claim 18, further comprising passing a fluid over a portion of the contaminated surfaces as the couplers are engaged.

20. The method of claim 18, further comprising sealing the second subassembly during engagement and opening the second subassembly only after the elastomer face seals and contaminated surfaces have been isolated.
